(19) United States
(12) Patent Application Publication
(10) Pub. No.: US 2004/0083449 A1
(43) Pub. Date: Apr. 29, 2004

(54) System and method for batch-feeding data

(75) Inventor: William C. Dodge, Mukilteo, WA (US)

Correspondence Address: FITCH EVEN TABIN AND FLANNERY, 120 SOUTH LA SALLE STREET, SUITE 1600, CHICAGO, IL, 60603-3406, US

(73) Assignee: The Boeing Comapny, Chicago, IL

(21) Appl. No.: 10/690,393

(22) Filed: Oct. 20, 2003

Related U.S. Application Data
(60) Provisional application No. 60/420,467, filed on Oct. 22, 2002.
(60) Provisional application No. 60/420,301, filed on Oct. 21, 2002.

(51) Int. Cl. G06F 9/44

(52) U.S. Cl. 717/101; 709/200

(57) ABSTRACT

A system and method for batch-feeding existing data that is formatted for one type of software application to another type of software application. The steps to provide the existing data to another type of software application include assembling the data into one-to-one tables, providing the one-to-one tables to a server, receiving the one-to-one tables at the server, reformatting the data from the one-to-one tables to a reformatted form according to rules of the software application, and entering the data in the reformatted form in a database. The system allows a user to save the existing data in the one-to-one tables on a share drive that is also accessible to a server. The user is then able to initiate the reformatting of the data by emailing the server a request to reformat the data.

This application claims priority to U.S. Provisional Patent Application No. 60/420,467, filed Oct. 22, 2002, the entirety of which is incorporated herein by reference. This application also claims priority to U.S. Provisional Application No. 60/420,301, filed Oct. 21, 2002, the entirety of which is incorporated herein by reference.

### BACKGROUND OF THE INVENTION

1. Field of the Invention

The present invention relates generally to computer software applications and data. Even more specifically, the present invention relates to a system and method for providing data formatted for use with one software application to another software application in a reformatted form.

2. Discussion of the Related Art

Software applications have become widely used tools that are used in a variety of ways in everyday life. Project management applications, for example, process data that includes information about tasks that need to be done, the resources to perform the tasks and deadlines that need to be met to stay on schedule.

It is common for several different software providers to have competing software applications in a certain market, and it is also common for each software application to format the data it processes in a manner that unique to each respective software application. In the project management software market, for example, Microsoft Project®, Artemis® and Primavera® brand project management applications each have their own formatting for the data that they utilize.

It is not unusual for users to accumulate a large amount of data that is formatted for use with a particular established software application. It is also not unusual for users to change from the established software application to a new software application.

It is often difficult, however, to access and/or process the accumulated data with the new software because the accumulated data is often in a format that the new software is unable to readily access and process.

### SUMMARY OF THE INVENTION

In one embodiment, the invention can be characterized as a method for providing data to a software application including the steps of: assembling the data into a plurality of tables at a client; providing the plurality of tables to a memory accessible by a server; sending a request, from the client to the server, to reformat the data in the plurality of tables; receiving the plurality of tables at the server in response to the server receiving the request to reformat the plurality of tables; reformatting the data in the plurality of tables to a reformatted form according to rules of the software application; and entering the data in the reformatted form in a database.

In another embodiment, the invention can be characterized as a method, and a computer readable medium embodied with code segments to carry out the method, of providing data to a database, the method including the steps of: receiving data formatted into one-to-one tables at a server; assembling the data from the one-to-one tables into data formatted according to rules of a software application; and entering the data formatted according to rules of the software application in a database.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a batch-feed system for reformatting data so the data may be processed by a software application according to one embodiment of the present invention;

FIG. 2 is a is a flowchart illustrating steps traversed by the batch-feed system of FIG. 1 in accordance with one embodiment of the present invention;

FIG. 3 is a is a flowchart illustrating steps carried out by the batch-feed system of FIG. 1 to convert project management data from one format to another format in accordance with one embodiment of the present invention;

FIG. 4 is a table showing one embodiment of activity data organized into a one-to-one relationship that is prepared during of the steps of FIG.3;

FIG. 5 is a table showing one embodiment of resource information organized into a one-to-one relationship that is prepared during the steps of FIG. 3;

FIG. 6 is a table showing one embodiment of relationship information organized in a one-to-one relationship that is prepared during the steps of FIG. 3; and

FIG. 7 is a table is one embodiment of global activity information organized in a one-to-one relationship that is prepared during the steps of FIG. 3.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

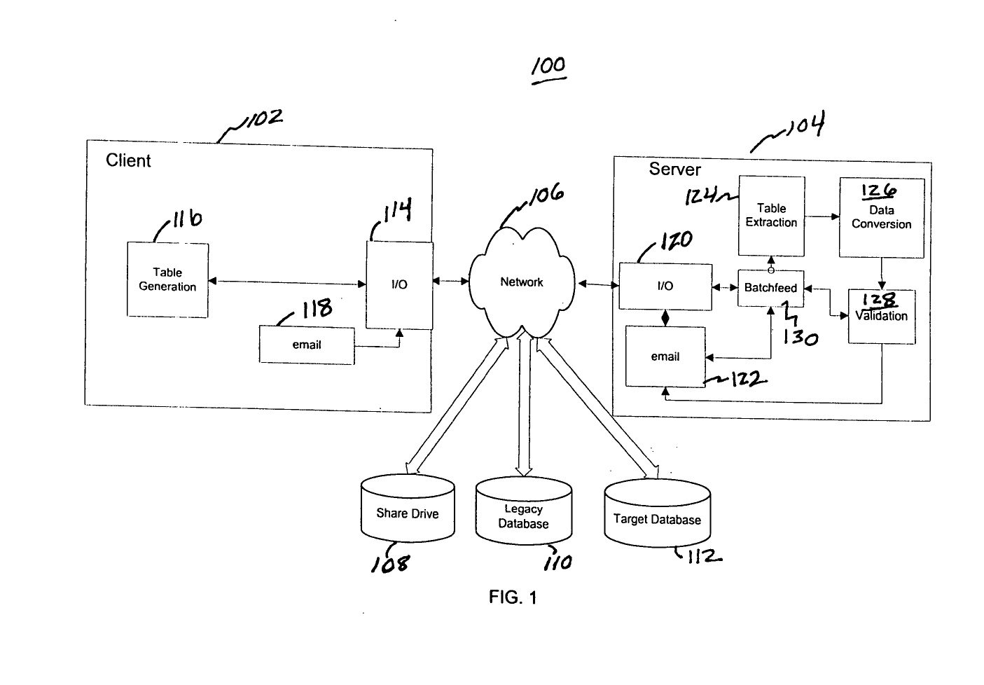

Referring first to FIG. 1, shown is a batch-feed system for reformatting data so the data may be processed by a software application according to one embodiment of the present invention. Shown are a client 102, a server 104, a network 106, and coupled to the network 106 are a share drive 108, a legacy database 110, and a target database 112.

Within the client 102 is an input/output (I/O) portion 114 that couples the client 102 to the network 106, and coupled to the I/O portion 114 is a table generation module 116 and an email module 118.

Within the server are a server I/O portion 120, a server email portion 122, a table extraction portion 124, a data conversion portion 126, a validation portion 128 and a batchfeed module 130. The server I/O portion 120 couples the server 104 to the network 106 and coupled to the server I/O portion 120 are the server email portion 122 and the batchfeed module 130. Coupled to the batchfeed module 130 is the table extraction portion 124 and coupled to the table extraction portion 124 is the data conversion portion 126. The validation portion 128 is shown coupled to the data conversion portion 126, the batchfeed module 130 and the email portion 122.

It should be recognized that the functional blocks shown in the server 104 and described herein are merely illustrative of functional capabilities of the server and not specific hardware or software structure. For example, as one of ordinary skill in the art recognizes, instructions implemented with software to carry out steps described herein need not be organized into the same discrete functional blocks that are shown within the server.

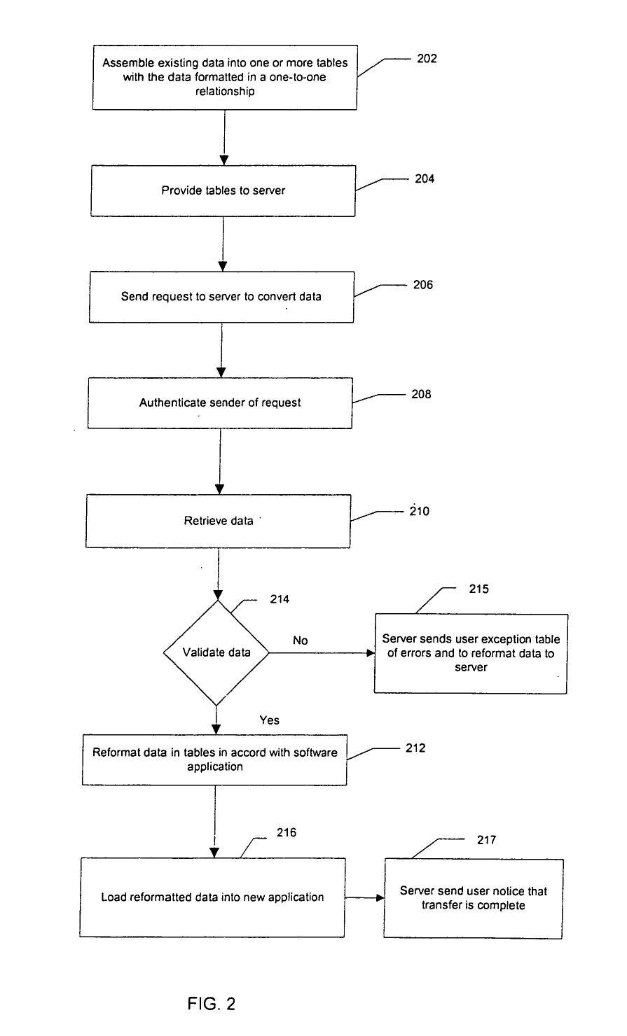

While referring to FIG. 1, simultaneous reference will be made to FIG. 2 which is a flowchart illustrating steps traversed by the batch-feed system of FIG. 1 when providing legacy data to a new application. As used herein legacy data refers to existing data that is formatted to be used with a legacy software application, i.e., an application used in the past to process the legacy data.

The client 102 in several embodiments is a general purpose computer that includes data processing capabilities, e.g., a central processing unit and memory, and is accessible by a user through a variety of means including a keyboard.

The table generation portion 116 in several embodiments is a spreadsheet application that is executed by hardware of the client 102. In some embodiments, the table generation portion 116 is implemented by an Excel® brand spreadsheet, but this is certainly not required. Generally, the table generation portion 116 allows a user to input data manually or import data from a variety of sources including the legacy database 110 or other media including floppy disks or optical media (e.g., CD ROM or DVD media). Additionally, the table generation portion 116 allows a user to create tables from imported data and export the tables to storage media including the share drive 108 on the network.

The email portion 118 in the client device in several embodiments is a typical email application allowing a user to compose, send and receive email to and from other users and/or devices, including the server 104, that are coupled to the network 106.

The I/O portions 114, 120 in the client 102 and the server 104 are implemented with a combination of software and hardware that facilitates transmission of information including files and email transmissions to and from the client 102 and server 104.

The network 106 in several embodiments, is a local area network, however, this is certainly not required, and one of ordinary skill in the art recognizes that embodiments of the present invention may be implemented with networks of varying size and infrastructure.

The legacy database 110 is a collection of data that is in a form that is readily accessible by a legacy software application, i.e., a software application that has been used in the past to process the data in the legacy database 110. In some embodiments the legacy database 110 is a collection of project management data, however, one of ordinary skill in the art recognizes that the present invention is not limited to any particular type of data.

The target database 112 is a database established to hold data that is format so that it is accessible by another software application that is able to process at least a portion of the data in the legacy database 110. In some embodiments, e.g., where the legacy database 110 is a project management database, the target database 112 is also a project management database that is able to store much of the same data in the legacy database 110 albeit in a different form.

Within the server 104, the batchfeed module 130 coordinates the processing of data that is carried out by the table extraction 124, the data conversion 126 and validation portions 128. All of these functional components within the server are implemented by a combination of hardware and software as is well known in the art.

In operation, when a user desires to provide legacy data, i.e., data formatted in accordance with a legacy software application, to another software application, the user first pulls the data from the legacy database 110 and assembles the data into one or more tables. In one embodiment for example, the data is assembled into a one-to-one relationship utilizing the table generation portion 116 (Step 202 of FIG. 2). It should be recognized that in some embodiments, the legacy data is obtained from either a removable or non-removable medium at the client 102 instead of being accessed via the network 106.

In several embodiments, in advance of the user obtaining the legacy data, the table generation portion 116 is provided with spreadsheets that have headings to identify for the user the type of information to place within a particular column or row. For example, in some embodiments, an Excel® spreadsheet is created with headings across a first row to help the user properly place legacy data into the spreadsheet.

Once the user has created the tables, the user provides the tables to the server 104 (Step 204 of FIG. 2). In several embodiments, the user provides the tables to the server 104 by saving the tables in a folder within the share drive 108 which is accessible by the server 104. In these several embodiments, the folder in the share drive 108 is named to associate the user with the folder. In one embodiment for example, the folder is given the first and or last name of the user.

Once the tables are provided to the server 104, the user then sends a request to the server 104 to convert the tables to a format accessible by the new application (Step 206 of FIG. 2). In several embodiments, the request is generated and sent by the user via the client email portion to the server 104. In one embodiment for example, if the user desires to have the data placed in the target database 112 then the user sends an email to the server 104 that has a name of the target database 112 in a subject line of the email. In another embodiment, if the target database 112 is organized with subsets of data, e.g., by different projects, then a name for the subset of data (e.g., a particular project name) is also added to the subject line of an email along with the name of the target database 112.

In some embodiments, the batch-feed module 130 authenticates the sender of the request to convert the data to verify that the user is authorized to have their request fulfilled (Step 208 of FIG. 2). In one embodiment for example, the user's email address is compared with a list of user's email addresses that are authorized to move data to the target database 112.

Once the server 104 receives the user's request to convert the data (and in some embodiments authenticated the user), the table extraction portion 124 retrieves the data (Step 210 of FIG. 2). In the embodiments where the user requests the conversion of data by sending an email, the server email portion 120 receives the email and the batch-feed module 130 parses out information about the sender, e.g., an identity of the user, and then prompts the table extraction portion 124 to locate and extract the tables from the share drive 108, e.g., by looking in the share drive 108 for a folder having a name that is associated with the user.

Before the reformatted data is placed in the target database 112, the data is validated against the target database 112 to ensure that meaningful data is entered in the target database 112 (Step 214 of FIG. 2). In some embodiments, if there are severe problems with the data, the user is informed via email message to recreate new tables (Step 215 of FIG. 2).

Once the server 104 has retrieved the tables, the data is reformatted by the data conversion portion 126 according to rules of the new software application (Step 212 of FIG. 2).

If there are not severe errors with the data, the data is sent in the reformatted structure to the target database 112. If there are relatively minor errors, the validation module 128 prepares and sends an exception report that is sent back to the user so that the user may perform editing of the data once it is entered in to the target database 112. In some embodiments, a report detailing the disposition of the data and the conversion process is sent to a response folder that is within a user's folder in the share drive. If there are no errors with the data, the validation module 128 sends an email message to the user that the data was successfully moved to the target database.

Once the data is in the target database 112, the user is then able to load the reformatted data into the new application (Step 216 of FIG. 2). Next the server sends the user a notice that the transfer is complete (Step 17 of FIG. 2).

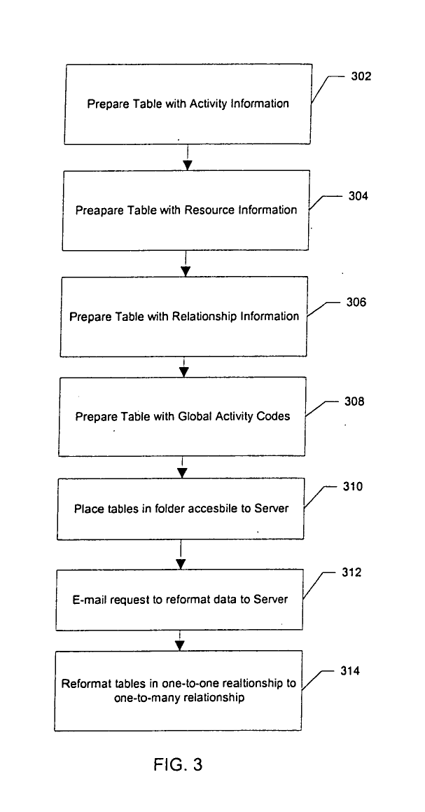

Referring next to FIG. 3, shown is a flowchart illustrating steps carried out by the batch-feed system of FIG. 1 to convert project management data from one format to another format in accordance with one embodiment of the present invention.

To facilitate project management data conversion from one format to another format, the existing data is first organized into tables. In several embodiments, four tables are prepared to facilitate data conversion: an activity information table, a resource information table, a relationship information table and a global activity code table (Steps 302-308).

It should be recognized that four tables are described for exemplary purposes only and that more or less than four tables may be utilized depending upon the data the user desires to provide to a target database.

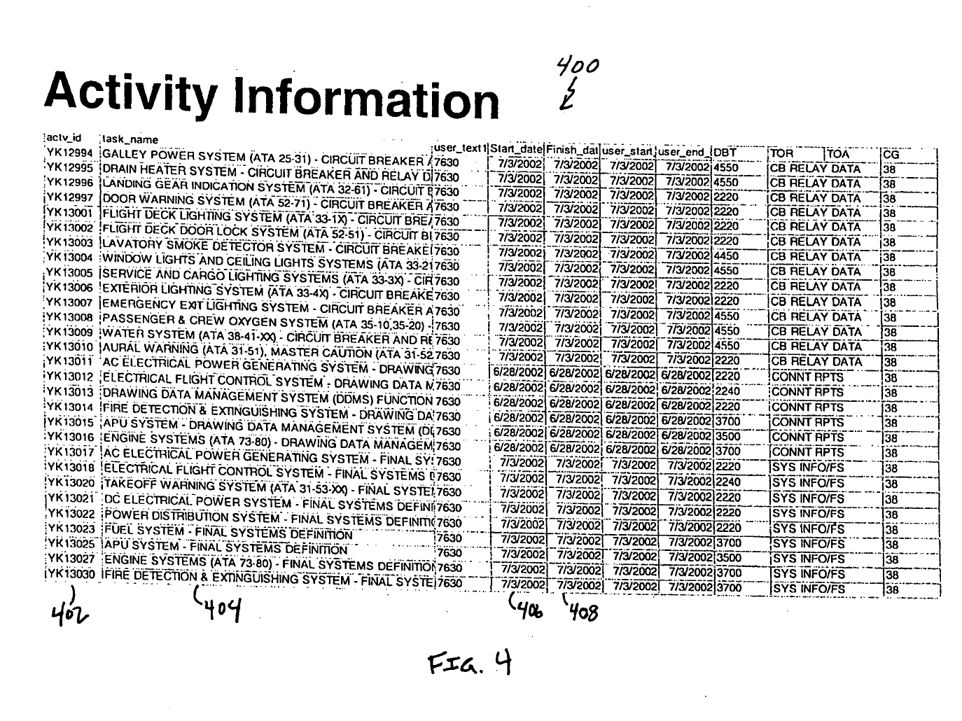

Referring to FIG. 4, shown is one embodiment of activity data organized into a one-to-one relationship that is prepared during Step 302 of FIG. 3. As shown, a first column 402 includes alpha-numeric activity identifiers, and for each activity identifier in the first column 402 there is information in the same row of other columns including a task name in a second column 404, start and end dates in fourth and fifth columns 406, 408 respectively and other information for each activity.

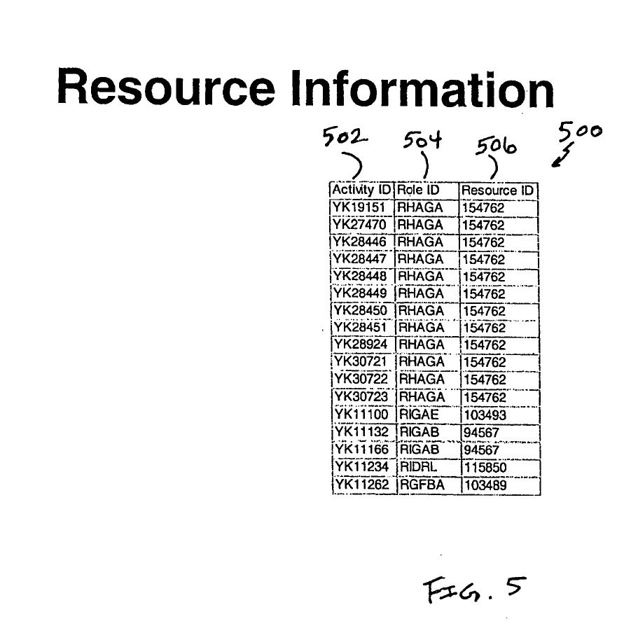

Referring next to FIG. 5, shown is one embodiment of resource information organized into a one-to-one relationship that is prepared during Step 304 of FIG. 3. As shown, a first column 502 includes alpha-numeric activity identifiers, and for each activity identifier in the first column 502, there is role identification and resource identification codes in second and third columns 504, 506 respectively.

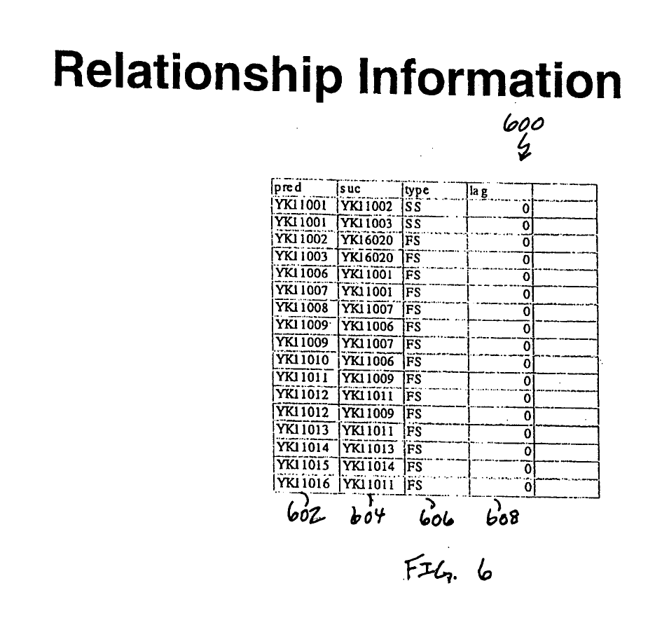

Referring next to FIG. 6, shown is one embodiment of relationship information organized in a one-to-one relationship that is prepared during Step 306 of FIG. 3. As shown, first and second columns 602, 604 of the relationship table include predecessor and successor activity identifiers respectively. In a third column 606 are type codes to indicate the relationship between the predecessor and the successor activity identification codes that are in the same row with each type code. Also shown is a “lag” column 608 that allows information about any lag time between the predecessor and successor activities.

In some embodiments, the type codes include “SS” indicating a start to start relationship between the predecessor and successor activities, “FS” indicating a finish to start relationship between the predecessor and successor activities and “FF” which indicates a finish to fish relationship between the predecessor and successor activities. Thus, the relationship information table establishes a timing relationship between each of the predecessor and successor activity pairs.

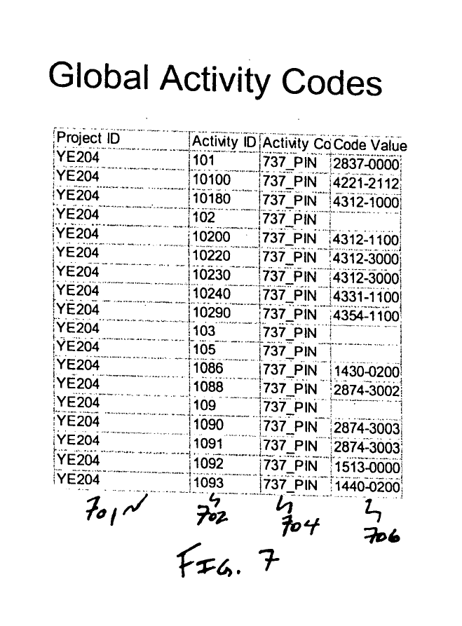

Referring next to FIG. 7, shown is one embodiment of global activity information organized in a one-to-one relationship that is prepared during Step 308 of FIG. 3. Shown are a first column 701 with project identifiers, a second column 702 with activity identifiers, a third column 704 with activity codes and a forth column 706 with code values. The activity codes and code values in several embodiments are global codes that are useable with any project. Thus, the global activity table associates activity identifiers for each project with activity codes and code values that may be used in other projects as well.

Referring back to FIG. 3, after the project data is formatted into the one-to-one tables, the tables are placed in a folder that is accessible to the server (Step 310). In several embodiments, the tables are placed in a share drive accessible by the server, and the user's name is incorporated into the name of the folder.

Once the user has placed the tables in a folder accessible by the server, the user then emails a request to the server to have the data in the one-to-one tables reformatted (Step 312). In some embodiments, the email from the user includes an identification of a target database and a particular project within the target database. In one embodiment, for example, the identification of the target database 112 and the particular project within the database are provided in the subject line of the email.

As previously discussed with reference to FIG. 2, the user in some embodiments is authenticated to help ensure that the request is from an authorized user. In one embodiment, for example, the authentication includes verifying the user's email user name is in a listing of authorized usernames.

Once the server 104 receives the request, the server retrieves the tables from the folder in the share drive 108 and reformats the data into one-to-many relationships that are in accord with business rules of the project management application that the data is to be used with. In some embodiments, the data is reformatted in accord with business rules of Primavera Project Planner®, but it should be recognized that the present invention is not limited to particular project management applications, nor project management data, and may extend to other types of data and software applications.

While the invention herein disclosed has been described by means of specific embodiments and applications thereof, numerous modifications and variations could be made thereto by those skilled in the art without departing from the scope of the invention set forth in the claims. For example, the present invention is not limited to project management data and is readily adapted to convert data of various types from one format to another format without departing from the scope of the claims.

I claim:

1. A method for providing data to a software application comprising the steps of:
assembling the data into a plurality of tables;
providing the plurality of tables to a memory accessible by a server;
sending a request, from a client to the server, to reformat the data in the plurality of tables;
receiving the plurality of tables at the server in response to the server receiving the request to reformat the plurality of tables;
reformatting, at the server, the data in the plurality of tables to a reformatted form according to rules of the software application; and
entering the data in the reformatted form in a database.

2. The method of claim 1, wherein the step of assembling the data into the plurality of tables comprises assembling the data at the client into the plurality of tables wherein at least one of the plurality of tables is formatted in a one-to-one relationship.

3. The method of claim 2, wherein the step of assembling comprises creating each of the plurality of tables in respective spreadsheets, wherein the step of providing the tables to the memory comprises providing the spreadsheets to the memory.

4. The method of claim 1, wherein the step of sending a request to reformat the data comprises sending the request via an email from the client to the server.

5. The method of claim 4, further comprising the step of:
authenticating a sender of the request to convert the data;
wherein the step of entering comprises entering the data in response to the step of authenticating producing a confirmation that the sender is authorized to enter the data in the database.

6. The method of claim 5, wherein the step of authenticating comprises authenticating the sender by comparing an email user name of the sender used in the email with a list of authorized users.

7. The method of claim 1, further comprising the step of:
validating, prior to the step of entering, the data by comparing the data with validation data in the database.

8. A method for providing data to a database comprising the steps of:
receiving, at a server, a request sent via email from a client to assemble the data according to rules of a software application;
receiving, in response to the email being received, the data from a memory accessible by both the server and a client;
assembling the data into data formatted according to the rules of the software application; and
entering the data formatted according to rules of the software application in a database.

9. The method of claim 8, wherein the step of receiving the data comprises receiving the data as a collection of tables organized in a one-to-one relationship.

10. The method of claim 9, wherein the step of receiving the data as a collection of tables comprises receiving each of the tables in a collection of respective spreadsheets, wherein the collection of spreadsheets are stored in a folder in the memory.

11. The method of claim 10, wherein the data is project management data and the collection of tables comprises tables selected from the group consisting of: an activity information table, a resource information table, a relationship information table and a global activity code attribute table.

12. The method of claim 8, further comprising the step of:
validating, prior to the step of entering the data, the data in the one-to-one tables.

13. The method of claim 12, further comprising the step of:
compiling an exception report during the step of validating; and
providing the exception report to another folder in the memory.

14. The method of claim 8, further comprising the step of:
authenticating a sender of the request to assemble the data based upon an email address of the sender;
wherein the step of entering comprises entering the data in response to the step of authenticating producing a confirmation that the sender is authorized to update the database.

15. The method of claim 8, wherein the step of assembling the into data formatted according to the rules of the software application comprises assembling the data from a one-to-one format into a one-to-many format.

16. A computer readable medium embodied with code segments for providing data to a database, the computer readable medium comprising:
a code segment for receiving a request at a server from a client to assemble data into a format that is in accord with rules of a software application;
a code segment for receiving, in response to the request from the client to assemble the data, the data at the server;
a code segment for assembling the data into the format that is in accord with rules of a software application; and
a code segment for entering the data that is in accord with rules of a software application into a database.

17. The computer readable medium of claim 16, wherein the code segment for receiving comprises a code segment for receiving the data as one-to-one tables from a memory accessible by both the server and a client.

18. The computer readable medium of claim 16, further comprising:
a code segment for validating the data prior to the data, that is in accord with rules of a software application, being entered into the database.

19. The computer readable medium of claim 16, wherein the code segment for receiving a request at a server from a client comprises a code segment for receiving the request at the server via an email from the client.

20. The computer readable medium of claim 19 further comprising:
a code segment for authenticating a sender of the request to assemble the data based upon an email address of the sender;
wherein the code segment for entering the data comprises a code segment for entering the data in response to the sender being authenticated by the code segment for authenticating.
